(19) United States
(12) Patent Application Publication
(10) Pub. No.: US 2002/0136005 A1
(43) Pub. Date: Sep. 26, 2002

(54) EMERGENCY FLASHLIGHT WITH A STAND

(76) Inventor: Dong H. Lee, Soo-Sung-Gu (KR)

Correspondence Address: JOHN K. PARK, PARK & SUTTON LLP, 3255 WILSHIRE BLVD., SUITE 1110, LOS ANGELES, CA, 90010, US

(21) Appl. No.: 09/816,487

(22) Filed: Mar. 26, 2001

(51) Int. Cl. F21L 19/00; F21L 4/00

(52) U.S. Cl. 362/171; 362/172; 362/190

(57) ABSTRACT

A flashlight device comprises a cylindrical casing defined by a top end, a bottom end, and an outer periphery sectioned into an upper tube and a lower tube, a first light emitter for flicker luminance, a second light emitter for steady luminance, and a wing stand including a ring having a rim and arms each having a base. The ring is slidably carried on the cylindrical casing to move up and down between the top end and the bottom end. Each arm collapsibly radiates from the rim to be either collapsed to the outer periphery or flapped open and the ring lowered.

### BACKGROUND OF THE INVENTION

The invention relates to a flashlight device. More particularly, the present invention relates to an emergency flashlight device having a stand, which enables the stand to reliably prop the device so that the stand can further assist an erection of the device on a target place, thereby maximizing product usability either for emergency lighting or for regular lighting.

As is well known, a flashlight is used as an lighting aid either indoors or outdoors. For an outdoor usage, such a conventional flashlight has to be carried by a user's hand. However, when a flashlight needs to be used for a longer period of time, the body of the flashlight disadvantageously shows instability in case the flashlight is placed on an outdoor table or on a bare spot such as a hood of a passenger car.

A demand for a flashlight is to enable a flashlight body to safely stand on itself regardless of a target stop for its placement. Another demand is to effectively converge the flashlight lighting on a same single direction so that an emergency lighting can reach farther.

### SUMMARY OF THE INVENTION

The present invention is contrived to overcome the conventional disadvantages. Therefore, an object of the invention is to enables a stand thereof to reliably prop the device so that the stand can further assist an erection of the device on a target place.

Another object of the invention is to effectively converge the lighting of the device on a same single direction A so that an emergency lighting can reach farther, thereby maximizing product usability.

To achieve the above-described objects, a flashlight device according to the present invention comprises a cylindrical casing defined by a top end, a bottom end, and an outer periphery, wherein the outer periphery is sectioned into an upper tube extending downwardly from the top end and a lower tube extending upwardly from the bottom end, a first light emitter disposed in the upper tube, wherein the first light emitter has a first light bulb for flicker luminance, a second light emitter attached to the bottom end of the cylindrical casing, wherein the second light emitter has a second light bulb for steady luminance, and a wing stand including a first support ring having a lower rim, and a plurality of hanging arms each having a base, wherein the first support ring is slidably carried on the cylindrical casing to move upwardly and downwardly along the outer periphery between the top end and the bottom end, wherein the hanging arms each collapsibly radiate from the lower rim of the support ring, whereby the hanging arms are either collapsed to the outer periphery when the first light bulb is not lit or flapped open and the support ring lowered in order for said each arm base seated on a target place to safely support the flash light device.

The second light emitter further comprises a base support having an upper surface, a lower surface, and a guide holder upwardly protruded from a circumference of the upper surface and spaced from the outer periphery so as to hold said each base of the hanging arms onto the outer periphery when required, and a second support ring detachably mounted on the lower surface of the base support, wherein the second light bulb is attached to the lower surface and protected by the second support ring.

The flashlight device may be formed such that the second support ring can serves a rotary switch to control the lighting of the first and second light bulbs. Also, the upper tube of the cylindrical casing can be either transparent or colored with transparency.

A cap having a height and fixed onto the top end of the cylindrical casing may be further provided so that the first support ring can be maintained between the top end and the bottom end of the cylindrical casing. The cap can be either transparent or colored with transparency. Further, each hanging arm has one or more support ridges formed on each outer surface of the hanging arms to prevent said each arm from bending.

In a preferred version, the flashlight device according to the present invention may include a plurality of first light bulbs having illuminants therein, wherein the first light bulbs are linearly aligned to identically face a single direction so that the lightning of the illuminants in the first light bulbs can converge on a single direction.

The advantages of the present invention are numerous in that: (1) when the device needs to stand on itself, the wing stand serves to flexibly and reliably prop the device body so that the device can safely maintain its erection on a target place, thereby improving device usability; (2) the lighting of the device can be effectively converged on a target direction by the provision of a plurality of linearly aligned illuminants facing a single direction, thereby enhancing product reliability; and (3) the wing stand having hanging arms adopts a collapsible mechanism so that the device can be easily flapped open and neatly collapsed on the device body, thereby maximizing portability and convenience.

Although the present invention is briefly summarized, the fuller understanding of the invention can be obtained by the following drawings, detailed description and appended claims.

### BRIEF DESCIPTION OF THE DRAWINGS

These and other features, aspects and advantages of the present invention will become better understood with reference to the accompanying drawings, wherein:

FIG. 1 is a front view showing a mechanism in which a wing stand is flapped open for propping a flashlight device according to the present invention;

FIG. 2 is another front view showing another mechanism in which the wing stand is collapsed on an outer periphery of the device body;

FIG. 3 is a perspective view showing a light bulb mechanism within an upper portion of the device body in FIG. 1; and

FIG. 4 is a schematic side view of FIG. 3.

### DETAILED DESCRIPTION OF THE PREFERRED EMBODIMENTS

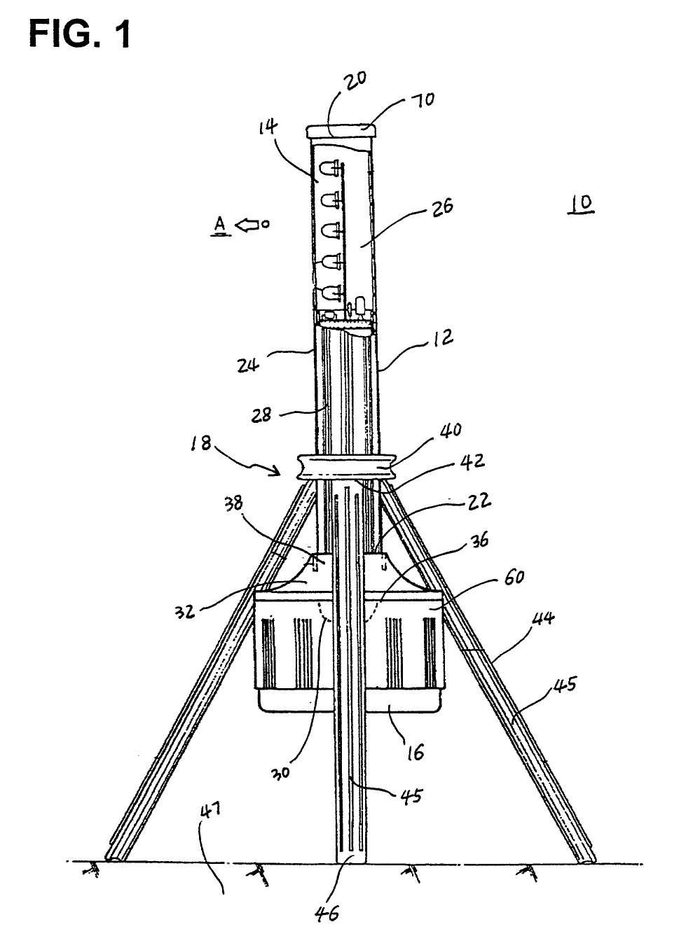

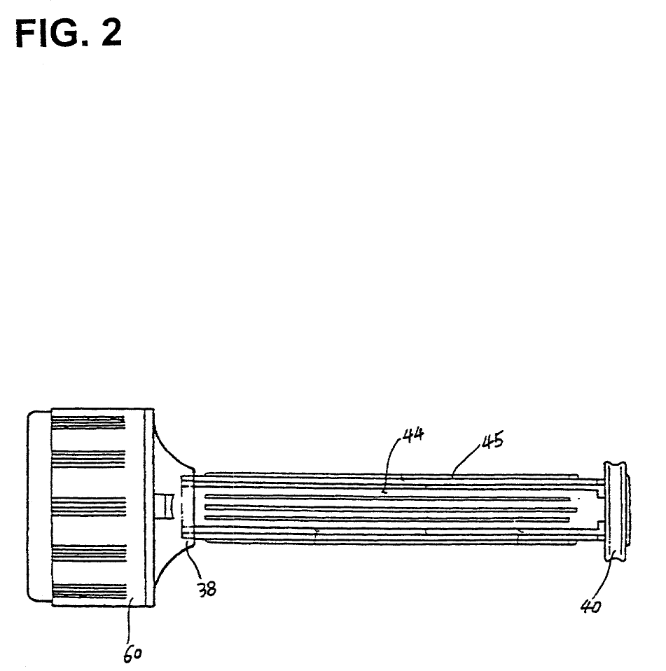

As shown in FIGS. 1 and 2, a flashlight device 10 according to the present invention comprises a cylindrical casing 12, a first light emitter 14, a second light emitter 16, and a wing stand 18.

The cylindrical casing 12 is defined by a top end 20, a bottom end 22, and an outer periphery 24. Preferably, the outer periphery 24 is sectioned into an upper tube 26 and a lower tube 28. The upper tube 26 extends downwardly from the top end 20 and the lower tube 28 extends upwardly from the bottom end 22. As expected in this construction, the upper tube 26 and lower tube 28 are incorporated into the cylindrical casing 12.

The first light emitter 14 is disposed within the upper tube 26. The first light emitter 14 may include a lighting mechanism for flicker luminance so as to signal emergency. Here, it is recommended that the upper tube 26 of the cylindrical casing 12 may be either substantially transparent or colored with transparency.

For a better performance, the second light emitter 16 is attached to the bottom end 22 of the cylindrical casing 12. The second light emitter 16 has a second light bulb 30 for steady luminance.

The second light emitter 16 further includes a base support 32 having an upper surface 34, a lower surface 36, and a guide holder 38 upwardly protruded from a circumference of the upper surface 34 and spaced from the outer periphery 24 of the cylindrical casing 12.

The wing stand 18 includes a first support ring 40 having a lower rim 42, and a plurality of hanging arms 44 each having a base 46. The first support ring 40 is slidably carried on the cylindrical casing 12 to move upwardly and downwardly along the outer periphery 24 between the top end 20 and the bottom end 22. So the hanging arms 44 are each provided to collapsibly radiate from the lower rim 42 of the first support ring 40. In this construction, the hanging arms 44 may be either collapsed to the outer periphery 24 or flapped open and at the same time the first support ring 40 lowered in order for each arm base 46 seated on a target place 47 to safely support the flashlight device 10. Each hanging arm 44 may include one or more support ridges 45 formed on each outer surface of the hanging arms 44 to efficiently prevent each arm 44 from bending.

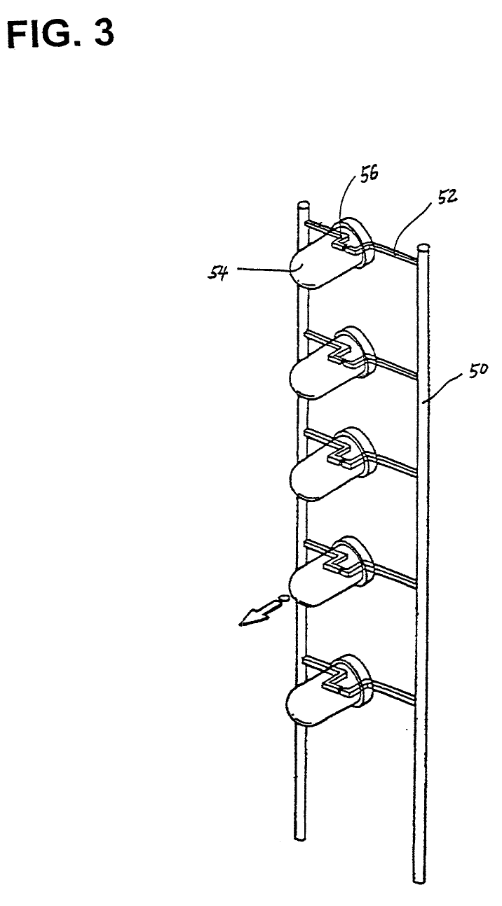

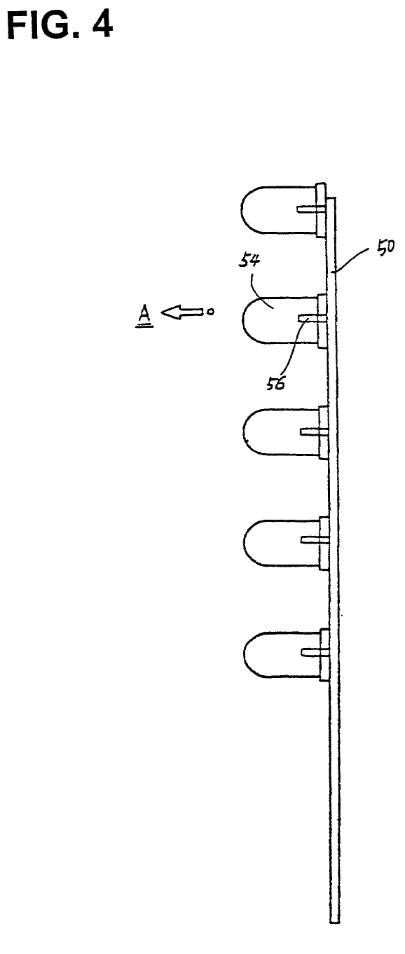

As further shown in FIGS. 3 and 4, the first light emitter 14 includes a pair of vertical terminals 50, one or more leads 52 fixedly linking the terminal pair 50 therebetween, and one or more light bulbs 54 correspondingly connected to the leads 52. Each light bulb 54 contains an illuminant 56 to generate the lighting when required. The electrical power for each light bulbs 30, 54 may come from batteries (not shown) stored in the lower tube 28 of the cylindrical casing 12.

In connection with the lighting mechanism, the second light emitter 16 further includes a second support ring 60 detachably mounted on the lower surface 36 of the base support 32. The second light bulb 30 is attached to the lower surface 36 of the base support 32 and protected by the second support ring 60.

As is well understood from FIG. 2, when the first light emitter 14 is not used or when the flashlight device 10 needs to be stored, the hanging arms 44 extending from the lower rim 42 of the first support ring 40 and radially swingable hanging from the lower rim 42 of the first support ring 40 are collapsed to the outer periphery 24 with each arm base 46 fitted between the guide holder 38 and the outer periphery 24 of the cylindrical casing 12.

As shown back in FIG. 1, when the first light emitter 14 needs to be used to deliver an emergency call or emergency signal to a distant person for a substantial time period, the hanging arms 44 are held and raised as much as the height of the guide holder 38 and then let go of the wing stand 18. At this moment, the first support ring 40 becomes lowered by its own weight and accordingly the hanging arms 44 become flapped open to thereby support the flashlight device 10 with an additional propping of each base 46 on a target place 47.

In an embodiment, the second support ring 60 serves as a rotary switch to control the lighting of the first and second light bulbs 30, 54. Each first light bulb 54 may be a light-emitting diode. Further, a cap 70 having a height may be fixedly mounted onto the top end 20 of the cylindrical casing 12 so that the first support ring 40 can be maintained between the top end 20 and the bottom end 22 of the cylindrical casing 12. The cap 70 may be either substantially transparent or colored with transparency.

An advantage of the present invention is that when the flashlight device 10 needs to stand on itself, the wing stand 18 serves to flexibly and reliably prop the device body 12 so that the device 10 can safely maintain its erection on a target place, thereby improving device usability. Another advantage is that the lighting of the device 10 can be effectively converged on a target direction A by the provision of the plurality of linearly aligned illuminants 56 facing a single direction A, thereby enhancing product reliability.

Further, the wing stand 18 having hanging arms 44 adopts a collapsible mechanism so that the device 10 can be easily flapped open and neatly collapsed on the outer periphery 24 of the device body 12, thereby maximizing portability and convenience.

Although the invention has been described in considerable detail, other versions are possible by converting the aforementioned construction. Therefore, the scope of the invention shall not be limited by the specification specified above and the appended claims.

What is claimed is:

1. A flashlight device, comprising:
a) a cylindrical casing defined by a top end, a bottom end, and an outer periphery, wherein the outer periphery is sectioned into an upper tube extending downwardly from the top end and a lower tube extending upwardly from the bottom end;
b) a first light emitter disposed in the upper tube, wherein the first light emitter has a first light bulb for flicker luminance;
c) a second light emitter attached to the bottom end of the cylindrical casing, wherein the second light emitter has a second light bulb for steady luminance; and
d) a wing stand including a first support ring having a lower rim, and a plurality of hanging arms each having a base, wherein the first support ring is slidably carried on the cylindrical casing to move upwardly and downwardly along the outer periphery between the top end and the bottom end, wherein the hanging arms each collapsibly radiate from the lower rim of the support ring, whereby the hanging arms are either collapsed to the outer periphery or flapped open and the first support ring lowered in order for said each arm base seated on a target place to safely support the flash light device.

2. The flashlight device of claim 1 wherein the second light emitter further comprises:
a) a base support having an upper surface, a lower surface, and a guide holder upwardly protruded from a circumference of the upper surface and spaced from the outer periphery so as to hold said each base of the hanging arms onto the outer periphery when required; and
b) a second support ring detachably mounted on the lower surface of the base support, wherein the second light bulb is attached to the lower surface and protected by the second support ring.

3. The flashlight device of claim 2 wherein the second support ring is a rotary switch to control the lighting of the first and second light bulbs.

4. The flashlight device of claim 1 wherein the upper tube of the cylindrical casing is substantially transparent.

5. The flashlight device of claim 1 further comprising a cap having a height and fixed onto the top end of the cylindrical casing, whereby the first support ring is maintained between the top end and the bottom end of the cylindrical casing.

6. The flashlight device of claim 5 wherein the cap is substantially transparent.

7. The flashlight device of claim 1 wherein said each hanging arm has one or more support ridges formed on each outer surface of the hanging arms to prevent said each arm from bending.

8. The flashlight device of claim 1 wherein the first light bulb is a light-emitting diode.

9. A flashlight device, comprising:
a) a cylindrical casing defined by a top end, a bottom end, and an outer periphery, wherein the outer periphery is sectioned into an upper tube extending downwardly from the top end and a lower tube extending upwardly from the bottom end;
b) a first light emitter disposed in the upper tube, wherein the first light emitter has a plurality of first light bulbs having illuminants therein for flicker luminance, wherein the first light bulbs are linearly aligned to identically face a single direction so that the lighting of the illuminants converge on a single direction;
c) a second light emitter attached to the bottom end of the cylindrical casing, wherein the second light emitter has a second light bulb for steady luminance; and
d) a wing stand including a first support ring having a lower rim, and a plurality of hanging arms each having a base, wherein the first support ring is slidably carried on the cylindrical casing to move upwardly and downwardly along the outer periphery between the top end and the bottom end, wherein the hanging arms each collapsibly radiate from the lower rim of the support ring, whereby the hanging arms are either collapsed to the outer periphery or flapped open and the first support ring lowered in order for said each arm base seated on a target place to safely support the flash light device.

10. The flashlight device of claim 9 wherein the second light emitter further comprises:
a) a base support having an upper surface, a lower surface, and a guide holder upwardly protruded from a circumference of the upper surface and spaced from the outer periphery so as to hold said each base of the hanging arms onto the outer periphery when required; and
b) a second support ring detachably mounted on the lower surface of the base support, wherein the second light bulb is attached to the lower surface and protected by the second support ring.

11. The flashlight device of claim 10 wherein the second support ring is a rotary switch to control the lighting of the first and second light bulbs.

12. The flashlight device of claim 9 wherein the upper tube of the cylindrical casing is substantially transparent.

13. The flashlight device of claim 9 further comprising a cap having a height and fixed onto the top end of the cylindrical casing, whereby the first support ring is maintained between the top end and the bottom end of the cylindrical casing.

14. The flashlight device of claim 13 wherein the cap is substantially transparent.

15. The flashlight device of claim 9 wherein said each hanging arm has one or more support ridges formed on each outer surface of the hanging arms to prevent said each arm from bending.

16. The flashlight device of claim 9 wherein said each first light bulb is a light-emitting diode.
